(19) United States
(12) Patent Application Publication
(10) Pub. No.: US 2016/0214608 A1
(43) Pub. Date: Jul. 28, 2016

(54) Cruise Control System for a Vehicle

(71) Applicant: JAGUAR LAND ROVER LIMITED, Coventry, Warwickshire (GB)

(72) Inventor: Elizabeth Packwood-Ace, Coventry, Warwickshire (GB)

(21) Appl. No.: 14/915,763

(22) PCT Filed: Sep. 3, 2014
(86) PCT No.: PCT/EP2014/068757

§ 371 Date: Mar. 1, 2016

(30) Foreign Application Priority Data
Sep. 3, 2013 (GB) 1315617.9

(51) Int. Cl. B60W 30/14; B60W 30/16

(52) U.S. Cl. CPC B60W 30/143; B60W 30/16; B60W 30/146; B60W 2420/42; B60W 2520/10; B60W 2520/125; B60W 2520/14; B60W 2550/148; B60W 2550/12; B60W 2720/10; B60W 2720/106

(57) ABSTRACT

The disclosure relates to a system for cruise controlling a vehicle. The system comprises a control unit configured to select a current driving control profile in dependence upon a determination by the system of an environmental and/or situational status of the vehicle. The said driving control profile optionally comprises an acceleration profile selected from two or more different acceleration profiles in dependence upon a determination by the system of an environmental and/or situational status of the vehicle. The said driving control profile comprises a deceleration profile selected from two or more different deceleration profiles in dependence upon a determination by the system of an environmental and/or situational status of the vehicle. The environmental and/or situational status of the vehicle may be determined by consideration of signals comprising data obtained from sensors or control modules comprised within or mounted to the vehicle and/or from information sources external to the vehicle.

### TECHNICAL FIELD

The present disclosure relates to a cruise control system for a motor vehicle and more particularly, but not exclusively, to a cruise control system configured to select a driving control profile for cruise controlling the vehicle in dependence upon an environmental and/or situational status of the vehicle as determined by the system. The driving control profile may comprise tuning maps or gradient parameters for determining rates of acceleration and deceleration that the cruise control system adopts when cruise controlling the vehicle. When the cruise control system is transitioning the vehicle between different vehicle cruise speeds, the rate of acceleration or deceleration may be selected in dependence upon the environment and/or situation of the vehicle, such that the cruise control system is able to adopt a driving style more appropriate for the current driving conditions.

Aspects of the invention relate to a system, to a vehicle, to a program and to a method.

### BACKGROUND

Cruise Control (CC) systems for motor vehicles, when manually activated, enable the motor vehicle to maintain a selected driving speed, referred to as a “Set Speed” or “vehicle cruise speed”. The driver maintains control of the vehicle and if the cruise control set speed cannot be maintained, for example, due to traffic conditions and/or legal speed limits, then the driver can either change the Set Speed or deactivate the cruise control (for example, by braking). Upon activation of cruise control, the system may cause the vehicle to accelerate to reach the Set Speed and typically does so using a fixed rate of acceleration.

Adaptive Cruise Control (ACC) systems for motor vehicles, when manually activated, enable the motor vehicle, referred to herein as a “host vehicle”, to maintain a selected vehicle cruise speed (Set Speed). The selected “vehicle cruise speed” (Set Speed) is adopted when there is no obstruction in the path of the host vehicle. The ACC systems also enable the host vehicle to adopt a selected “vehicle cruise headway” when a preceding (target) vehicle is disposed in the path of the host vehicle such that the host vehicle cannot maintain the vehicle cruise speed. Such a driving scenario may also be referred to as a “following” situation. The vehicle cruise headway is typically defined as a minimum time gap between the host vehicle and the closest preceding vehicle that is in its path, i.e. the target vehicle. The ACC system computes a suitable vehicle speed to adopt in a following situation based upon the selected headway. The ACC system continues to maintain the selected minimum headway until the closest preceding (target) vehicle is detected to move out of the path of the host vehicle, at which point the ACC system may cause the host vehicle to resume the vehicle cruise speed.

In both the Cruise Control and Adaptive Cruise Control systems, control units of the systems are typically configured to cause the vehicle to accelerate rapidly from a starting speed to the Set Speed (without overshooting the Set Speed). Similarly, when decelerating, the systems typically adopt a deceleration gradient that rapidly transitions the vehicle from the starting speed to a new set speed. The ramp rates of acceleration and deceleration are typically not adjustable by the driver; are typically pre-programmed; and typically do not consider the current driving conditions that the vehicle is in.

In some known CC and ACC systems the speed of the vehicle is controlled by adjustment of the throttle position using an actuator. Feedback sensors may provide a vehicle speed data signal and a throttle position data signal to control units of the systems which sometimes utilise a proportional control strategy to iteratively compute the adjustment of the throttle position in dependence upon the vehicle speed signal.

It is desirable for cruise control systems and adaptive cruise control systems to have a less artificial feel. It is desirable for cruise control systems to assist driver's compliance with legal speed limits; however it is also desirable to retain driver control. With increased use of variable speed limit zones, it is also becoming more common for part of a driver's journey to pass through variable speed limit zones. Due to the changing nature of the legal speed limit in the zones a driver cannot learn the speed limit and compliance with variable speed limits can be more difficult for a driver. It is the object of the present invention to provide an improvement in the field of cruise control and adaptive cruise control systems.

### SUMMARY OF THE INVENTION

Aspects of the invention provide a system, a vehicle, a method and a program.

According to one aspect of the invention for which protection is sought, there is provided a system for cruise controlling a vehicle, the system comprising a control unit configured to select a driving control profile in dependence upon a determination by the system of an environmental and/or situational status of the vehicle.

Optionally, said driving control profile comprises an acceleration profile selected from two or more different acceleration profiles in dependence upon a determination by the system of an environmental and/or situational status of the vehicle.

Optionally, said driving control profile comprises a deceleration profile selected from two or more different deceleration profiles in dependence upon a determination by the system of an environmental and/or situational status of the vehicle.

Optionally, the system is configured to determine an environmental and/or situational status of the vehicle by consideration of signals comprising data obtained from sensors or control modules comprised within or mounted to the vehicle and/or from information sources external to the vehicle.

Optionally, the system is configured to determine an environmental status of the vehicle by consideration of signals comprising data that include one or more or a combination of:
(i) whether the rear and/or front wiper speed is above or below a threshold speed;
(ii) whether a detection of rain by a rain sensor is above or below a rain threshold;
(iii) whether the front head lights are above or below a first light threshold
(iv) whether a status of a fog light is above or below a second light threshold;
(v) whether the ambient temperature is below a threshold temperature; and
(vi) data from a terrain response control module.

The first light threshold referred to above may refer to an amount of illumination provided by the emitted lights, which may also be referred to as the intensity of the emitted light. The intensity may optionally be quantified between an “off status” of the front head lights wherein the intensity is zero; and a “maximum on status” of the front head lights wherein the intensity of the emitted light is a maximum; and any number of stages between off and maximum.

The second light threshold referred to above may refer to an amount of illumination provided by the emitted light(s), which may also be referred to as the intensity of the emitted light. The intensity may optionally be quantified between an “off status” of the fog light(s) wherein the intensity is zero; and a “maximum on status” of the fog light(s) wherein the intensity of the emitted light is a maximum; and any number of stages between off and maximum.

Optionally, said data is used to compute an estimated surface friction mu value of the road upon which the vehicle is travelling and in dependence upon said estimated surface friction mu value an appropriate driving control profile is selected by the system or in dependence upon said estimated surface friction mu value the environmental status is quantified.

Optionally, the data is weighted and summed in order to quantify the environmental status.

Optionally, the system is configured to determine a situational status of the vehicle by consideration of signals comprising data that includes one or more or a combination of:
(i) whether the tyre pressure of one or more or all of the front and/or rear tyres is above or below a threshold pressure range;
(ii) whether a sports mode is activated;
(iii) whether a level of light emitted by an HID light is above or below a light level threshold;
(iv) whether a status of a brake bias valve is above or below a valve threshold
(v) whether a winter mode is activated;
(vi) a lateral acceleration of the vehicle; and
(vii) a yaw rate of the vehicle.

The “light level threshold” referred to above may refer to a physical or spatial level of the light emitted by an HID light, which threshold may be considered relative to a feature of the vehicle.

Optionally, the data is weighted and summed in order to quantify the situational status.

Optionally, in dependence upon a quantified environmental status and in dependence upon a quantified situational status a driving control profile is selected.

Optionally, the system controls the vehicle so as to maintain a vehicle cruise speed.

Optionally, the vehicle cruise speed is selected by a driver of the vehicle.

Optionally, the system is configured to determine a current legal speed limit and is configured to display or otherwise communicate the current legal speed limit as determined by the system to a driver of the vehicle, as an indicated speed limit, for prompting the driver of the vehicle to select the indicated speed limit as the vehicle cruise speed.

Optionally, the system is configured to determine a current legal speed limit and is configured to determine an appropriate vehicle speed in dependence upon said current legal speed limit as determined by the system and in dependence upon an environmental and/or situational status of the vehicle and wherein the system is configured to display or otherwise communicate the determined appropriate vehicle speed to a driver of the vehicle as an indicated speed limit, for prompting the driver of the vehicle to select the indicated speed limit as the vehicle cruise speed.

Optionally, the system comprises a means for a driver to select the indicated speed limit as the vehicle cruise speed and upon a driver selecting the indicated speed limit as the vehicle cruise speed by deploying said means, the system is configured to adopt and maintain the indicated speed limit as the vehicle cruise speed.

Optionally, the system comprises a means for a driver to select an off-set speed relative to the indicated speed limit as the vehicle cruise speed and upon a driver selecting said off-set speed relative to the indicated speed limit as the vehicle cruise speed by deploying said means, the system is configured to adopt and maintain the off-set indicated speed limit as the vehicle cruise speed.

Optionally, the off-set speed is the indicated speed limit plus or minus 10 kmh⁻¹.

Optionally, the system is configured to display or otherwise communicate the indicated speed limit to a driver of the vehicle for prompting the driver of the vehicle to select the indicated speed limit as the selected vehicle cruise speed, only if the determined indicated speed limit is lower than the vehicle cruise speed already selected by the driver.

Optionally, the system is configured to communicate the indicated speed limit to a driver of the vehicle a maximum number of times or for a specified period, before ceasing to communicate the indicated speed limit to a driver of the vehicle.

Optionally, the system is configured to monitor the current legal speed limit and upon determining a change in the current legal speed limit, the system is configured to determine a new appropriate vehicle speed in dependence upon a new legal speed limit and is configured to communicate the new appropriate vehicle speed as a new indicated speed limit to a driver of the vehicle a maximum number of times before ceasing to communicate that new indicated speed limit.

Optionally, the maximum number of times is two.

Optionally, the vehicle cruise speed is selected by the system and is automatically adopted by the system and wherein the system is configured and arranged to cause the vehicle to accelerate or decelerate such that the vehicle maintains the vehicle cruise speed.

The system may be configured to monitor the legal speed limit and may be configured to determine a current legal speed limit; and may be configured to select the vehicle cruise speed in dependence upon the legal speed limit.

Optionally, the system is configured to: determine a new legal speed limit before the vehicle reaches a threshold at which the new legal speed limit applies; determine a new vehicle cruise speed in dependence upon the new legal speed limit; and cause the vehicle to accelerate or decelerate at a sufficient rate such that the actual vehicle speed matches the new vehicle cruise speed within a predefined distance or time gap of the new legal speed limit threshold.

Optionally, the system is configured to display or otherwise communicate the new legal speed limit as determined by the system to a driver of the vehicle, as an indicated speed limit, for allowing the driver of the vehicle an opportunity to cancel automatic adoption of the indicated speed limit as the vehicle cruise speed by the system.

Optionally, the system is configured to determine an appropriate vehicle speed in dependence upon said current legal speed limit as determined by the system and in dependence upon an environmental and/or situational status of the vehicle as determined by the system and wherein the system is configured to automatically adopt the determined appropriate vehicle speed as the vehicle cruise speed, which appropriate vehicle speed may be equal to or less than the current legal speed limit.

Optionally, the system is configured to determine a new appropriate vehicle speed ahead of a threshold at which a new legal speed limit applies and is arranged to cause the vehicle to accelerate or decelerate at a ramp rate determined in dependence upon the environmental and/or situational status of the vehicle as determined by the system such that the actual vehicle speed matches the new vehicle cruise speed, at a distance or time gap relative to the new legal speed limit threshold dependent upon the relative time at which the new legal speed limit is determined and a new appropriate vehicle speed is determined and in dependence upon the starting actual vehicle cruise speed relative to the new appropriate vehicle speed.

Optionally, a new vehicle cruise speed is only automatically adopted if it is less than a current vehicle cruise speed.

Optionally, the system is configured to determine a current driving control profile and therefore deceleration ramp rate in dependence upon the environmental and/or situational status of the vehicle as determined by the system and wherein the system is configured to automatically adopt the determined appropriate vehicle speed as the vehicle cruise speed using said deceleration ramp rate.

Optionally, the system determines the current legal speed limit including a current variable legal speed limit using any one or a combination of:
(i) data from a navigation system;
(ii) imaging of traffic speed limit signs optionally in conjunction with a traffic sign recognition system; and/or
(iii) data from a smart speed limit sign or an information medium associated therewith.

Optionally, the system controls the vehicle so as to maintain a vehicle cruise headway.

Optionally, the vehicle cruise headway is selected by a driver of the vehicle.

Optionally, the system is configured to determine an appropriate vehicle headway in dependence upon braking distance data for the vehicle cruise speed and for environmental and/or situational status of the vehicle as determined by the system.

Optionally, the system is configured to display or otherwise communicate the determined appropriate vehicle headway to a driver of the vehicle as an indicated headway, for prompting the driver of the vehicle to select the indicated headway as the vehicle cruise headway.

Optionally, the system comprises a means for a driver to select the indicated headway as the vehicle cruise headway and upon a driver selecting the indicated headway as the vehicle cruise headway by deploying said means, the system is configured to adopt and maintain the indicated headway as the vehicle cruise headway.

Optionally, the system is configured to display or otherwise communicate the indicated headway to a driver of the vehicle for prompting the driver of the vehicle to select the indicated headway as the selected vehicle cruise headway, only if the determined indicated headway is greater than the vehicle cruise headway already selected by the driver.

Optionally, the system is configured to communicate the indicated headway to a driver of the vehicle a maximum number of times or for a specified period, before ceasing to communicate the indicated headway to a driver of the vehicle.

Optionally, the system is configured to monitor the vehicle cruise speed and environmental and/or situational status of the vehicle and upon determining a change in the appropriate vehicle headway, the system is configured to communicate a new indicated headway to a driver of the vehicle, a maximum number of times before ceasing to communicate that new indicated headway.

Optionally, the maximum number of times is two.

According to another aspect of the invention, there is provided a vehicle comprising the system of the above-described aspect.

According to a further aspect of the invention, there is provided a method of controlling a vehicle according to above-mentioned aspect, the method comprising determining an environmental and/or situational status of the vehicle; and selecting in dependence thereon a current driving control profile; and cruise controlling the vehicle using the current driving control profile.

According to another aspect of the invention, there is provided a program for a control unit, which when running on the control unit causes the control unit to carry out the method of the above-mentioned aspect.

Within the scope of this application it is expressly intended that the various aspects, embodiments, examples and alternatives set out in the preceding paragraphs, in the claims and/or in the following description and drawings, may be taken independently or in any combination thereof. For example, features described in connection with one embodiment are applicable to all embodiments, unless such features are incompatible.

### BRIEF DESCRIPTION OF THE DRAWINGS

Embodiments of the invention will now be described, by way of example only, with reference to the accompanying drawings, in which:

FIG. 1 is a schematic representation of a vehicle having an improved cruise control (CC) system according to an embodiment of the disclosure, wherein the cruise control system of the vehicle is configured to maintain a selected vehicle cruise speed (Set Speed);

FIG. 2A is a graphical representation of a first acceleration ramp rate which can form part of a first selectable current driving control profile and which can be adopted by the CC system of FIG. 1 in dependence upon the system determining that the vehicle has a first environmental or situational status;

FIG. 2B is a graphical representation of a second acceleration ramp rate which can form part of a second selectable current driving control profile and which can be adopted by the CC system of FIG. 1 in dependence upon the system determining that the vehicle has a second environmental or situational status;

FIG. 2C is a graphical representation of a third acceleration ramp rate which can form part of a third selectable current driving control profile and which can be adopted by the CC system of FIG. 1 in dependence upon the system determining that the vehicle has a third environmental or situational status;

FIG. 3 is a flow-diagram illustrating part of an algorithm executed by a controller of the improved CC system according to FIG. 1 in order to determine a current driving control profile;

FIG. 4 is a schematic representation of a host vehicle having an improved adaptive cruise control (ACC) system according to an embodiment of the disclosure. The host vehicle is shown following a target vehicle and the ACC system of the host vehicle automatically maintains a vehicle cruise headway relative to the target vehicle;

FIG. 5 is a schematic representation of a vehicle having an improved adaptive cruise control system according to yet a further embodiment of the disclosure, wherein the vehicle is being driven within a variable speed limit zone and the improved adaptive cruise control system is configured to determine the variable speed limit and an estimated new legal speed limit threshold at which it applies;

FIG. 6A is a graphical representation of the change in actual speed of a vehicle having a system similar to that shown in FIG. 6, wherein the system automatically adopts a new appropriate vehicle speed in dependence upon a change in legal speed limit, which new appropriate vehicle speed is adopted ahead of the new legal speed limit threshold shown in FIG. 6;

FIG. 6B is a graphical representation of the change in actual speed of a vehicle having a system similar to that shown in FIG. 6, wherein the system automatically adopts a new appropriate vehicle speed in dependence upon a change in legal speed limit and/or a current driving control profile, which new appropriate vehicle speed is adopted ahead of a the new legal speed limit threshold;

FIG. 6C is a graphical representation of the change in actual speed of a vehicle having a system similar to that shown in FIG. 6, wherein the system automatically adopts a new appropriate vehicle speed in dependence upon change in legal speed limit and/or a current driving control profile, which new appropriate vehicle speed is not adopted until just after the new legal speed limit threshold and wherein priority is given to the current driving control profile.

### DETAILED DESCRIPTION OF EMBODIMENTS

Detailed descriptions of specific embodiments of the vehicles, systems, methods, control units and programs of the present invention are disclosed herein. It will be understood that the disclosed embodiments are merely examples of the way in which certain aspects of the invention can be implemented and do not represent an exhaustive list of all of the ways the invention may be embodied. Indeed, it will be understood that the vehicles, systems, methods, control units and programs described herein may be embodied in various and alternative forms. The figures are not necessarily to scale and some features may be exaggerated or minimised to show details of particular components. Well-known components, materials or methods are not necessarily described in great detail in order to avoid obscuring the present disclosure. Any specific structural and functional details disclosed herein are not to be interpreted as limiting, but merely as a basis for the claims and as a representative basis for teaching one skilled in the art to variously employ the invention.

The present invention relates generally to cruise control systems that monitor and account for the environment and situation that a vehicle is in. By taking into account the environment and/or situation of the vehicle an improved cruise control system is provided. Benefits of the system optionally include automatic selection of an appropriate current driving control profile in dependence upon the environmental and/or situational status of the vehicle. The current driving control profile optionally includes an appropriate acceleration and/or deceleration ramp rate. For example, in wet, icy or low-visibility conditions, the cruise control systems of the disclosure automatically determine an environmental status that reflects the fact that the conditions require caution and in response to such a determination adopt an appropriate current driving control profile which may comprise acceleration and deceleration ramp rates that are more appropriate and likely to be safer for the current environmental conditions.

As a further example, cruise control systems disclosed herein are configured to monitor the current legal speed limit. In some embodiments, the CC systems disclosed herein are configured to take appropriate action to assist the driver in driving within the legally imposed speed limits. This may cut down on the work the driver might otherwise have to do in adapting the vehicle cruise speed manually in response to the driver's own recognition that the legal speed limit has or is about to change. By having to set a cruise control speed for the cruise control system to maintain on his behalf, the driver may be caught out by a change in legal speed limit, particularly in variable speed limit zones. Such variable speed limit zones require an extra degree of driver vigilance because they cannot be learned and variable speed limits can be more difficult to adhere to due to their changing nature. By providing systems that monitor legal speed limits and that optionally communicate the same to the driver or automatically adopt them, the cruise control systems of the disclosure may improve safety and may improve driver adherence to legal speed limits. In conjunction with selection of a driving profile in dependence upon the environmental and/or situational status of a vehicle, as determined by the system, systems disclosed herein may provide an improved cruise controlled driving experience.

It will be recognised that known cruise control (CC) and adaptive cruise control (ACC) systems interact with many other vehicle control systems and control modules to manage the vehicle during cruise control driving. Typically, known CC and ACC systems can control the speed, acceleration and braking of a vehicle. Such systems do not typically manage the direction of the vehicle or its steering and as such the terms “manage driving” and “management of the driving” are used herein to refer to the CC and ACC system's control of vehicle functions such as the speed, acceleration and braking of a vehicle and should not necessarily be taken to mean that the driver is no longer in control of the vehicle. Typically, and in the embodiments illustrated herein, the driver remains in control of the vehicle, but certain functions that the driver would have done, such as depress the throttle pedal to maintain a driver required vehicle speed are carried out for the driver albeit only under the driver's instruction. Nevertheless in envisaged embodiments the improvement disclosed herein may be adopted in a vehicle which when activated does take over full automated driving of the vehicle.

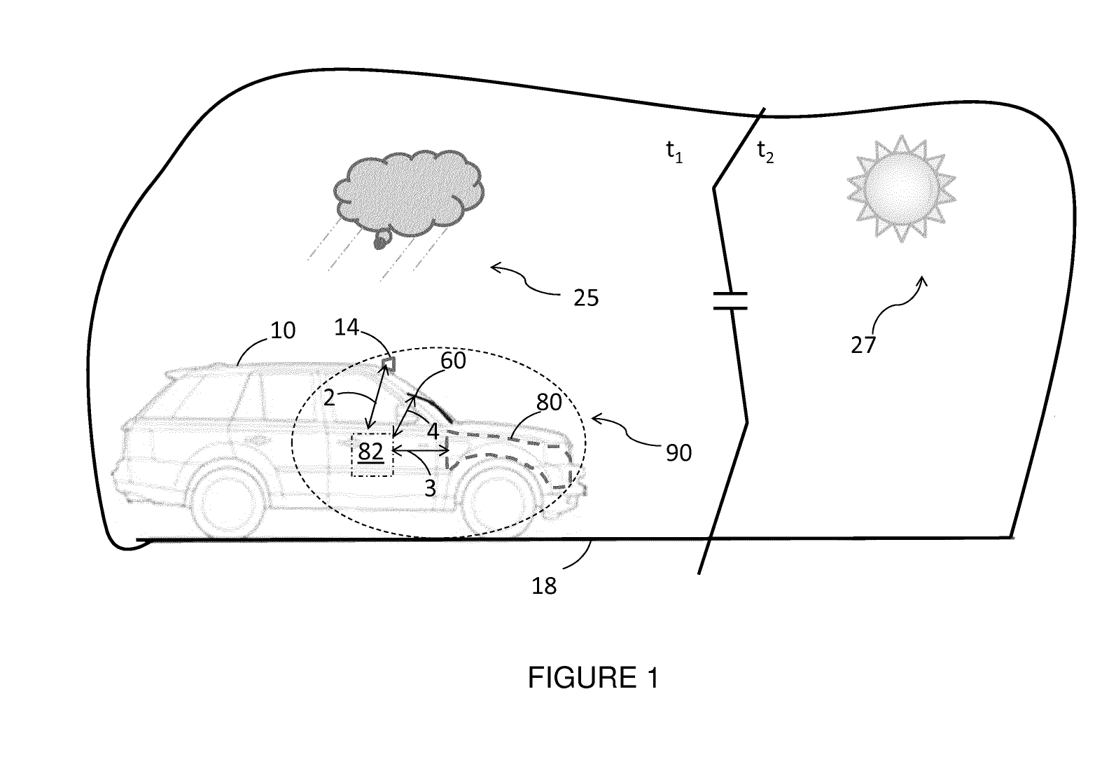

Referring now to FIG. 1, there is shown a vehicle 10 having a cruise control (CC) system 90. The CC system 90 comprises a control unit 82 which may be coupled to a local interconnect network (LIN) and/or to a controller area network (CAN) illustrated schematically by references 2, 3 and 4. The CC system 90 permits a driver to select a vehicle cruise speed (also referred to as Set-point) which is adopted and maintained by the system 90 when cruise controlling the vehicle 10. The CC system 90 autonomously maintains the vehicle cruise speed until the driver deactivates or suspends operation of the CC system 90 or until the vehicle cruise speed is changed, optionally by the driver in response to a prompt from the CC system 90. Optionally, deactivation or suspension of the CC system 90 is achieved by activating a brake pedal (not shown) of the vehicle 10.

The control unit 82 is structured and arranged to monitor (i.e. receive data signals relating to) one or more current vehicle status parameters. The one or more current vehicle status parameters in this illustrated arrangement include, but not necessarily exclusively: the actual vehicle driving speed (c.f. “vehicle cruise speed” which is a parameter that is the target speed the CC system 90 is aiming to maintain) and the status of a mechanism for autonomous adjustment of the vehicle driving speed. When the vehicle 10 is being cruise controlled by the system 90, the system 90 issues control signals to autonomously manage the acceleration or deceleration of the vehicle 10 in order to maintain the Set-point vehicle cruise speed. To achieve this, the control unit 82 of the CC system 90 may communicate with auxiliary control units or control modules for other components or systems of the vehicle 10. For example, the control unit 82 may communicate, (either directly or indirectly via the vehicle's communication network (CAN) with a control mechanism for autonomously adjusting the vehicle's speed. Such a control mechanism may be housed within the engine or engine bay 80 of the vehicle 10.

In the present embodiment, the vehicle 10 comprises an internal combustion engine (not shown) and an actuator (not shown) is provided for autonomously adjusting the throttle position. A data signal from the actuator or a sensor associated with it is sent to the control unit 82. By constantly receiving a data signal of actual vehicle speed and the difference between the actual vehicle speed and the Set-point vehicle cruise speed, the control unit 82 can cause the actuator to be appropriately adjusted in order to achieve and then maintain the Set-point vehicle cruise speed.

The control unit 82 is beneficially structured and arranged to monitor the current environment 25 that the vehicle 10 is being driven in; and optionally to monitor the current situation of the vehicle 10. Based upon this monitoring the control unit 82 is configured to determine an environmental and/or situational status of the vehicle 10. Monitoring of the environment 25 in which the vehicle 10 is being driven optionally includes monitoring of weather conditions and/or road quality and conditions, optionally to determine a friction value (a mu number for the road surface). Monitoring of the situation in which the vehicle 10 is being driven optionally includes monitoring of factors that indicate whether the vehicle 10 is heavily laden and/or is towing for example.

The control unit 82 is structured and arranged to automatically select a current driving control profile in dependence upon the environmental and/or situational status of the vehicle 10 as determined by the system 90. The current driving control profile is adopted by the cruise control system 90 for a given period and in the present embodiment, is selected from a limited range of current driving control profile options. In difficult driving conditions, the cruise control system 90 is configured to adopt a more conservative or cautious driving profile, whereas in good driving conditions, the cruise control system 90 is configured to adopt a more confident driving profile. In between the two extremes one or more other current driving control profiles are available for selection by the control unit 82 of the system 90. In the presently described and illustrated embodiment, each current driving control profile is characterised by acceleration ramp rates and deceleration ramp rates. In other embodiments, it is envisaged that the current driving control profile may comprise additional or alternative parameters. For example, in adaptive cruise control systems where a headway is maintained between the vehicle and a target vehicle, a driving control profile may contain a headway more appropriate for the environmental and/or situational status for which the driving control profile is tailored. In a heavily laden vehicle or a vehicle that is towing, a driving control profile may comprise an increased headway value in order to provide a greater braking distance.

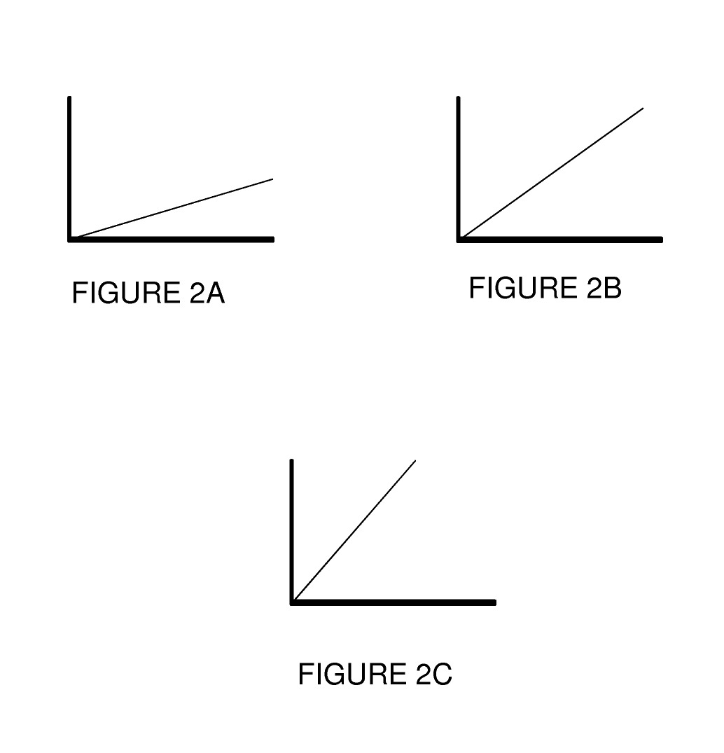

The acceleration and deceleration ramp rates are optionally stored in a memory associated with the control unit 82. The acceleration and deceleration ramp rates may be provided in a range of suitable formats. For example, the acceleration and deceleration ramp rates may be provided in the form of an algorithm, tuning map or look-up table. In the present embodiment, a series of three current driving control profiles are available for selection (in dependence upon the environmental and/or situational status of the vehicle 10 as determined by the system 90), which each comprise a different acceleration and deceleration ramp rate or tuning map. A first current driving control profile having a first tuning map for acceleration and a first tuning map for deceleration corresponds to a first environmental and/or situational status of the vehicle 10; a second current driving control profile having a second (different) tuning map for acceleration and a second (different) tuning map for deceleration corresponds to a second environmental and/or situational status; and a third current driving control profile corresponding to a third environmental and/or situational status comprises a third (different) tuning map for acceleration and a third (different) tuning map for deceleration. Referring to FIGS. 2A to 2C, first, second and third acceleration ramp rate maps are represented graphically (and not necessarily to scale). As can be seen, the first tuning map of FIG. 2A provides for a relatively shallow rate of change of vehicle speed. A second tuning map (FIG. 2B) has a slightly steeper rate of change of vehicle speed; and a third tuning map (FIG. 2C) has a steepest rate of change of vehicle speed.

In the environmental and vehicle situation illustrated in FIG. 1, the vehicle 10 is not heavily laden and is not towing. At time t₁, the vehicle 10 is being cruise controlled by the CC system 90 in a rainy atmosphere 25. At time t₂, the vehicle 10 is cruise controlled by the CC system 90 in a sunny, dry environment 27. The system 90 has determined, at time t₁, based upon an assessment of the current environment 25 and situation, that the environmental and situational status of the vehicle is quantified as a second status. Moisture in the atmosphere may be detected by one or more rain sensors (not shown) and/or due to the speed of the windscreen wipers 60 being non-zero the second environmental and/or situational status has been determined. Optionally, the system 90 may determine a current environmental and/or situational status by computing an estimated surface mu value of the road 18 upon which the vehicle 10 is travelling. In other embodiments, and indeed in the presently illustrated arrangement, data is gathered from sensors and is weighted and/or summed in order to quantify the environmental and/or situational status. Optionally, an environmental status may be determined separately and independently to a situational status and then the two combined in order to determine an overall status in dependence upon which a current driving control profile is selected.

Returning to FIG. 1 and the system illustrated therein, monitoring of the environment 25 is continuous and as the vehicle 10 progresses, the system 90 continues to assess the environment. At time t₂, the road surface 18 is dry, the ambient temperature is slightly higher, the windscreen wipers 60 have a zero speed and the system 90 quantifies the environmental and/or situational status as a “three”, the third current driving control profile is selected and thereby the third acceleration tuning map (see FIG. 2C) is adopted for changing speed.

Whereas the monitoring of the environment 25 and vehicle situation is continuous, implementation of a newly selected driving profile optionally only takes place once the cruise control system 90 is not causing the vehicle to accelerate or decelerate. In other words, the control unit 82 does not necessarily change the rate or manner in which the vehicle 10 accelerates part way through a transition from a first speed to a second speed.

This is further explained with reference to FIG. 1. Wherein at time t₁, the control unit 82 has selected the second driving profile and the second tuning map for the acceleration or deceleration response to be followed by the cruise control system 90 should acceleration or deceleration be required. At time t₂ the control unit 82 selects the third driving profile and the third tuning map for the acceleration or deceleration response to be followed by the cruise control system 90 should acceleration or deceleration be required. However, if during a period spanning t₁ and t₂, the cruise control system 90 was in the process of changing the actual speed of the vehicle 10, then the third driving profile would not necessarily be implemented and adopted until after the vehicle 10 is no longer in a speed transition, but is again being driven at a selected vehicle cruise speed. In this way a change in driving style, during a transition from one vehicle speed to another vehicle speed, does not occur. This beneficially (albeit optionally) ensures a smooth driving experience and smooth control of the vehicle 10 during cruise control.

Alternatively, it is envisaged that, in some embodiments where a selection of a different current driving control profile is attempted during a period of acceleration or deceleration, that the different current driving control profile is adopted immediately. Further alternatively, it is envisaged that in other embodiments where selection of a more cautious driving profile is attempted during a period of acceleration or deceleration, the more cautious driving profile is adopted immediately, but if selection of a current driving control profile having a greater rate of acceleration or deceleration is attempted, it is not adopted until after the CC system 90 has finished accelerating or decelerating.

It will be appreciated that continual adjustment of the actual vehicle speed in order to maintain the Set-point vehicle cruise speed may involve a degree of acceleration or deceleration. Such adjustment may be of small order, for example changes of ±1 to 1.5 kmh⁻¹ in actual vehicle speed may be achieved by very short periods of acceleration. In contrast, it will be appreciated that more significant changes in actual vehicle speed, for example of ±20 to 80 kmh⁻¹ involve a more significant acceleration or deceleration and that a change in current driving control profile during such a more significant acceleration or deceleration might be more noticeable. As such where reference has been made to a speed transition period during the exertion of which a change in current driving control profile may (or may not) be prohibited, reference is being made to a more significant acceleration of the vehicle and not one that is a mere iterative adjustment to maintain vehicle cruise speed.

Returning to the embodiment depicted in FIG. 1, the environmental monitoring conducted by the control unit 82 is carried out by gathering data from sources within the vehicle 10 and from information sources external to the vehicle 10. The received environmental data is examined and quantified in order to determine a current environmental status and optionally, in dependence thereon, as to which current driving control profile the cruise control system 90 should attempt to select and adopt in managing the vehicle 10 during cruise control operation.

The environmental data signals from sources within the vehicle 10 may be issued:
(i) directly from a sensor or component of the vehicle 10; and/or
(ii) directly from an auxiliary control unit (that may receive the data signal from a sensor or derive another data signal which is then issued to the control unit 82); and/or
(iii) via a communications network, for example, a local interconnect network (LIN) and/or a controller area network (CAN).

In the arrangement of FIG. 1, such environmental data signals from sources within the vehicle 10 optionally include:
(i) data signals from one or more imaging means such as a camera 14 positioned to image the environment 25 ahead of and/or about the exterior of the vehicle 10;
(ii) data signals from a temperature sensor (not shown) for measuring the external ambient temperature (an ambient temperature below about 4° C. indicates an increased likelihood of ice and can be used as an indicator that cautious driving parameters should be adopted by the CC system 90);
(iii) signals comprising data about operation of the rear and/or front windscreen wipers (60) for rain detection (data relating to on/off status; to wiper speed; to wiper frequency and/or duration may be gathered and analysed);
(iv) data signals from one or more moisture sensors (not shown) optionally disposed on the front and/or rear windscreens and able to detect the presence of rain, mist and snow for example; and
(v) signals comprising data of the status of fog lights (an active fog light is indicative of the presence of fog and heavy spray within the environment 25 and can be used as an indicator that cautious driving parameters should be adopted by the CC system 90).

Optionally, in other embodiments, the vehicle has a terrain response system. The terrain response system comprises data of the terrain mode, for example, ice and snow, sand, mud and ruts and this can again be used in determining and quantifying the environmental status. A data signal may be issued from the terrain response system directly, or indirectly via the CAN, to the CC system 90 control unit 82.

The environmental data signals from sources external to the vehicle 10 may be obtained for example:
(i) via wireless access to the internet; and/or
(ii) from a GPS (global positioning system) device; and/or
(iii) from a traffic information service.

The environmental data signals from sources external to the vehicle 10 may provide information about the roads and terrain, legal speed limits, current road conditions and current traffic conditions, any and all of which may be utilised in determining which cruise control driving profile should be adopted by the CC system 90.

The situational monitoring conducted by the control unit 82 is carried out by gathering data from sources typically only within the vehicle 10. The received situational data is examined and quantified and in dependence upon a combination of the quantified environmental and situational status, the cruise control system 90 can select and adopt an appropriate current driving control profile for use in managing the vehicle 10 during cruise control operation.

The situational data signals may be issued:
(i) directly from a sensor or component of the vehicle 10; and/or
(ii) directly from an auxiliary control unit (that receives or derives data and then issues a data signal to the control unit 82); and/or
(iii) via a communications network, for example, a local interconnect network (LIN) and/or a controller area network (CAN).

In the arrangement of FIG. 1, the system 90 monitors a number of parameters to determine, for example, whether or not the vehicle 10 is towing or is heavily laden, and in response to making such a determination, the control unit 82 determines that a more cautious, i.e. shallower acceleration/deceleration profile should be adopted compared to times when, the vehicle 10 is not towing, not heavily laden or is in for example, a sports mode. In the arrangement of FIG. 1, such situational data signals optionally include:
(i) one or more tyre pressure data signals (a higher than normal pressure in one or more of the tyres may suggest that the vehicle 10 is laden);
(ii) data signal relating to the position of a (Xenon) High Intensity Discharge (HID) lights level (if the light level has been raised this indicates that the vehicle is laden/towing);
(iii) a data signal indicative of the operation of a brake bias valve (if the vehicle 10 requires a greater brake effort than expected in normal conditions, this may indicate that the vehicle 10 is laden/towing).

Additionally or alternatively, in other embodiments it is envisaged that a controller or port for towing lights may provide a data signal indicative of whether towing lights are connected. However, whilst it is unlikely that a positive signal from a towing light controller or port would be issued when no towing was taking place, a driver of the vehicle 10 may not always connect towing lights when towing is taking place and as such data gathered therefrom may not be conclusive. Nevertheless, in conjunction with an assessment of other data signals as described above, a data signal from a controller or port for the towing lights may enable the control unit 82 to make a more confident decision that the vehicle 10 is in a situation where a slower acceleration/deceleration profile is appropriate and to tailor the cruise controlling of the vehicle 10 accordingly.

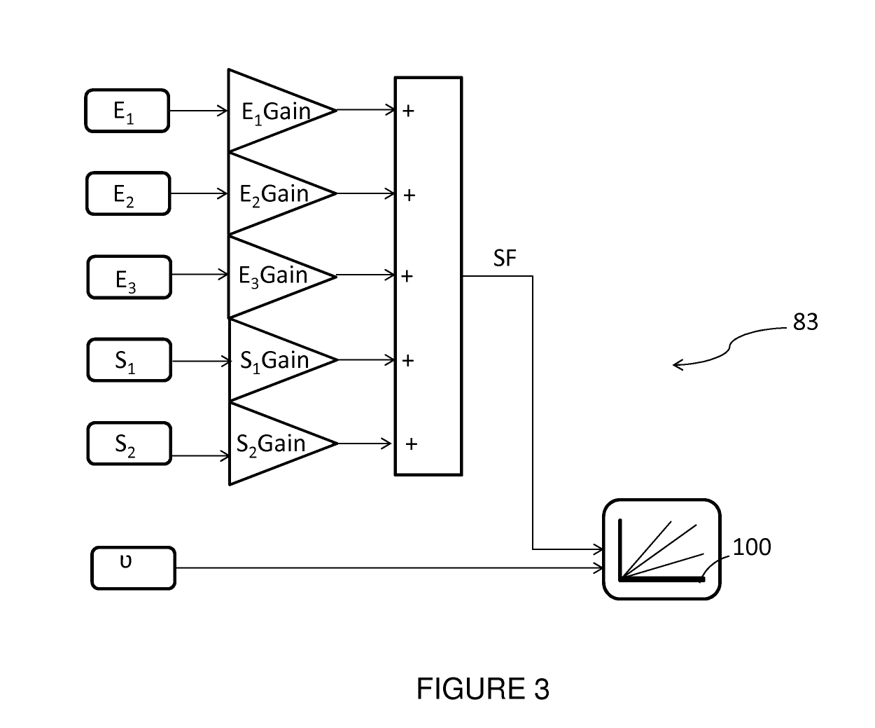

Referring now to FIG. 3, there is shown a schematic illustration of an algorithm 83 that is performed by the controller 82 of the CC system 90 in determining a quantified environmental and/or situational status.

The quantified environmental and/or situational status is referred to also as a status factor (SF). In an envisaged embodiment, the status factor ‘SF’ is computed by assigning to a “flag” (E₁GAIN, E₂GAIN, E₃GAIN) for each of a series of environmental factors E₁, E₂, E₃ a ‘zero’ or a ‘one’ in dependence upon the observed environment. For example, a first environmental factor E₁, in the present embodiment, relates to a determination as to whether the environment in which the vehicle 10 is present is categorised as wet or dry. If wet conditions are observed then the “wet flag” E₁GAIN is set to equal 1. If dry conditions are observed then the “wet flag” E₁GAIN is set to equal 0. In the present embodiment wet conditions are considered to be observed if a rain sensor (not shown) detects moisture and/or if the wipers (60) are activated (i.e. have a non-zero speed) for a threshold period, which optionally is 10 s and is optionally calibrateable.

A second environmental factor E₂ relates to a determination as to whether the surface of the road (18) in which the vehicle 10 is travelling is considered to be icy. If icy conditions are observed, the “ice flag” ‘E₂GAIN’ is set to equal 1. If icy conditions are not observed, the “ice flag” ‘E₂GAIN’ is set to equal 0. In the present embodiment an icy road surface is considered to be observed if the external ambient temperature is below 4° C. and/or if a terrain response control module indicates the presence of ice or snow.

A third environmental factor E₃ relates to a determination as to whether visibility is good or poor. If poor visibility conditions are observed then the “visibility flag” ‘E₃GAIN’ is set to equal 1. If poor visibility conditions are not observed then the “visibility flag” ‘E₃GAIN’ is set to equal 0. In the present embodiment poor visibility conditions are considered to be observed if the fog light status is active.

Similarly, a first situational factor S₁ that relates to whether the vehicle 10 is towing or loaded is comprised within the algorithm illustrated schematically in FIG. 3. If a towing or loaded condition is observed then the “towing or loaded flag” ‘S₁GAIN’ is set to equal 1. If a towing or loaded condition is not observed then the “towing or loaded flag” ‘S₁GAIN’ is set to equal 0. In the present embodiment towing is observed if a signal from a brake bias valve indicates that a greater braking effort is required and/or if the HID lights level has been raised.

A second situational factor S₂ relates to high-tyre pressure and if observed a “high tyre pressure flag” ‘S₂GAIN’ will be set to equal 1. High tyre pressure may be defined as any one or more of the tyres exhibiting a pressure that is greater than the vehicle's normal tyre pressure by about 30% or more and is optionally calibrateable, optionally in dependence upon temperature. In other embodiments, other thresholds may be set. The threshold is preferably a calibrateable value that can be defined in dependence upon the size and configuration of the vehicle 10.

At time t₂ in FIG. 1, the algorithm of FIG. 3 computes a Status Factor ‘SF’ that is zero. (E₁GAIN=0; E₂GAIN=0; E₃GAIN=0; S₁ GAIN=0; and S₂GAIN=0). At time t₁ however wet conditions are observed and E₁GAIN=1, the Status Factor may also equal 1. As such in FIG. 3 the actual vehicle speed (u) and status factor are optionally both used together in order to select an appropriate current driving control profile comprising an appropriate acceleration/deceleration ramp rate for the given conditions. Optionally from a referenceable set of look-up tables 100 stored in a memory associated with the controller 82. Optionally in other envisaged embodiments, acceleration and deceleration ramp rates are computed rather than referenced.

It will be recognised that in other embodiments a greater or fewer number of factors can be taken into account in quantifying the environmental status. A weighting of the different factors may also be included in some embodiments. It will also be recognised that there are various ways in which a decision algorithm can be configured and arranged and FIG. 3 is provided only to illustrate one of many envisaged methods of quantifying the environmental and/or situational status of a vehicle for determining in dependence thereon a current driving control profile that should be adopted. Additionally it will be realised that in other embodiments the environmental factors E₁, E₂, E₃ may be considered and weighted and summed separately to the situational factors S₁, S₂.

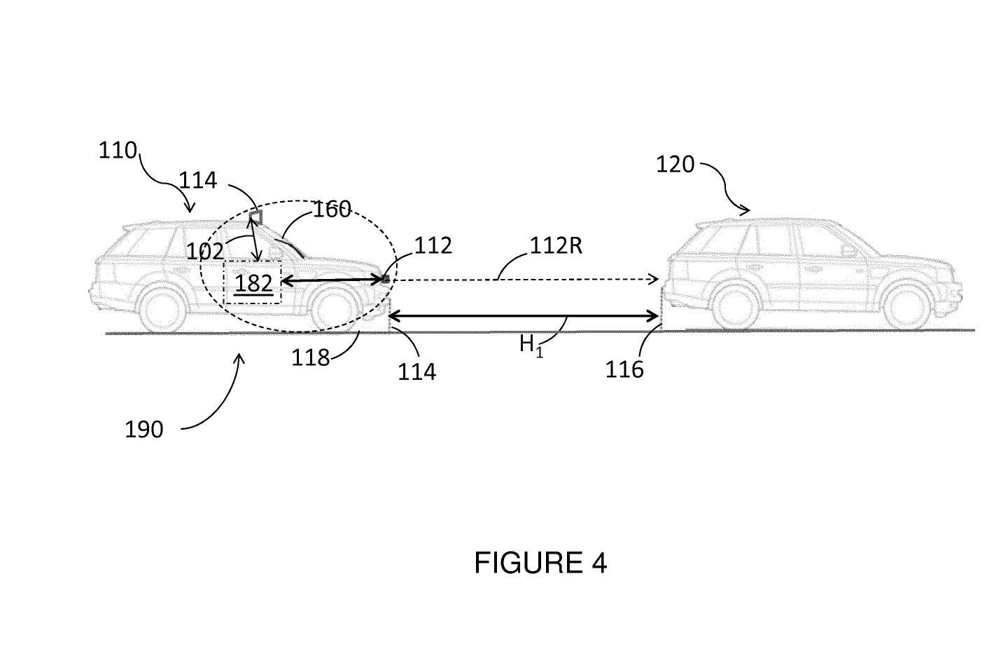

Referring now to FIGS. 4 to 6C there are shown additional embodiments of the disclosure. In the further illustrated embodiments, like reference numerals have where possible been used to denote like parts, albeit with the addition of the prefix “100” and “200” to illustrate that these features belong to the additional embodiments respectively. For conciseness of description, like features are not necessarily described in further detail.

Referring now to FIG. 4, there is shown a host vehicle 110 having an ACC system 190. The ACC system 190 comprises a control unit 182 which may be coupled to a local interconnect network (LIN) and/or to a controller area network (CAN). The control unit 182 of the ACC system 190 is configured to receive data signals from a radar sensor 112 provided to determine a distance 112R between the host vehicle 110 and target vehicle 120 disposed in its path. The ACC system 190 enables a vehicle cruise headway ‘H₁’ to be selected and adopted by the ACC system 190 in cruise controlling the vehicle 110 such that if a set point vehicle cruise speed cannot be maintained because of the presence of a target vehicle 120, the vehicle cruise headway ‘H₁’, is maintained instead. In the present embodiment vehicle cruise headway is defined as a time gap between the two moving vehicles 110, 120. In other envisaged embodiments vehicle cruise headway may be defined by a different measurement unit, for example a gap in metres (m).

The ACC system 190 is configured similarly to the CC system 90 in that it is configured to monitor the environment and/or situational status of the vehicle 190 and either quantify that status in terms of a factor or compute an estimation of a likely surface value (mu) for the road 118. Optionally the controller 182 is configured to execute an algorithm 183 in which the quantified environmental and/or situational status of the vehicle 110 is quantified and used, optionally in conjunction with the actual vehicle speed to select a current driving control profile. The current driving control profile at least comprises an appropriate acceleration ramp rate map and/or deceleration ramp rate map to be used automatically by the system 190 in cruise controlling the vehicle 110.

Optionally, in dependence upon the status factor (the quantified environmental and/or situational status) the controller 182 is additionally configured to determine (in conjunction with current vehicle speed) an appropriate vehicle headway. The appropriate vehicle headway is optionally based upon a safe braking distance for the current vehicle speed which is then increased, optionally in proportion to, the status factor SF. In this way, as the driving conditions worsen (lower visibility, more rain, increased likelihood of ice and/or vehicle towing) the suggested appropriate vehicle headway is also increased to provide a greater gap between the host vehicle 110 and a target vehicle 120 in its path.

The ACC system 190 comprises an HMI, optionally in the form of a button on or proximate the steering wheel of the vehicle 110 and/or in the form of a visible display on or proximate the instrument cluster (wherein the vehicle's 110 speedometer display may be provided). The HMI is used to communicate to the driver of the vehicle 110, optionally via the display (not shown), the determined appropriate vehicle headway. The communicated suggested headway, is referred to as an indicated headway. Optionally, in the present embodiment, the system 190 is configured to display or otherwise communicate the indicated headway to a driver of the vehicle 110, for prompting the driver of the vehicle 110 to select the indicated headway as the selected vehicle cruise headway, only if the determined indicated headway is higher than the vehicle cruise headway already selected by the driver. This provides a more conservative system that only provides an alternative suggestion of a cruise headway to the driver if it is greater than the vehicle cruise headway that the driver has already elected the system 190 to adopt.

It is preferred that the indicated headway is only communicated as a prompt to the driver a limited maximum number of times or for a maximum period. This is in order for the system 190 to provide clear, succinct communications that are not overly distracting for the driver. Optionally, in the present embodiment, the indicated headway is provided on a display screen with an accompanying beep. After an initial beep and/or display of the indicated headway, the system 190 may repeat the prompt a further time before offering no further communications of that indicated headway. As such, in the present arrangement, the maximum number of times before ceasing to communicate the new indicated headway is two. In other embodiments it is envisaged that the indicated headway may be displayed, optionally with a continuous or intermittent beep for a set period of time, for example 5s. To avoid too much communication of suggestions which may be irritating or distracting for the driver the system 190 is optionally configured to continue to monitor the actual vehicle speed and environmental and/or situational status and is configured to repeatedly compute an appropriate headway. Only if a new indicated headway is greater than the last indicated headway does the system 190 communicate this to the driver. To avoid too great an amount of “suggestion” by the system 190, which again may be irritating or distracting to the driver, the computed appropriate headway may converted into a closest one of a limited number of values for indicated headway. For example, whereas the computation of appropriate headway based upon braking distance, actual vehicle speed and status factor ‘SF’ may take a continuous range of values, those values are rounded (preferably up) into one of five indicated headway values, for example 1.5 s, 1.8 s, 2.1 s, 2.3 s and 2.5 s. The values listed here are merely illustrative and as an example only. The system 190 may be configured to display an indicated headway of say 1.8 s, which is higher than a driver selected vehicle cruise headway of 1.7 s. The indicated headway may be communicated twice (using, for example, a display and an audible alert) and thereafter the system 190 may cease communicating the prompt for the driver to adopt the (higher) indicated headway. Then, at a later time, the SF has increased due to the presence of rain, and the system 190 computes a new appropriate headway of about 2.05 s. This is rounded to the acceptable value for indicated headway of 2.1 s. The new indicated headway (2.1 s) is again higher than the driver selected vehicle cruise headway of 1.7 s and is different from the last communicated indicated headway and therefore is also communicated. Again, in this embodiment of the system 190, the new indicated headway value of 2.1 s is communicated twice (using, for example, a display and an audible alert) and thereafter the system 190 may cease communicating the prompt for the driver to adopt the (higher) indicated headway.

It is envisaged that in other embodiments, an appropriate headway may be automatically adopted by the ACC system 190. Additionally, in envisaged embodiments, the system 190 may be configured only to adopt a new computed appropriate headway if it is greater than a current value for the vehicle cruise headway. As such, in some arrangements, the system does not necessarily communicate an appropriate headway, in the form of an indicated headway to the driver, but automatically adopts it. In some embodiments, the indicated headway to be automatically adopted by the system may still be communicated to the driver and the driver may be required to press a button or take other action in order to stop the system from adopting the indicated headway, rather than using a button to accept and thereby cause the system to adopt the indicated headway (as in the illustrated embodiment).

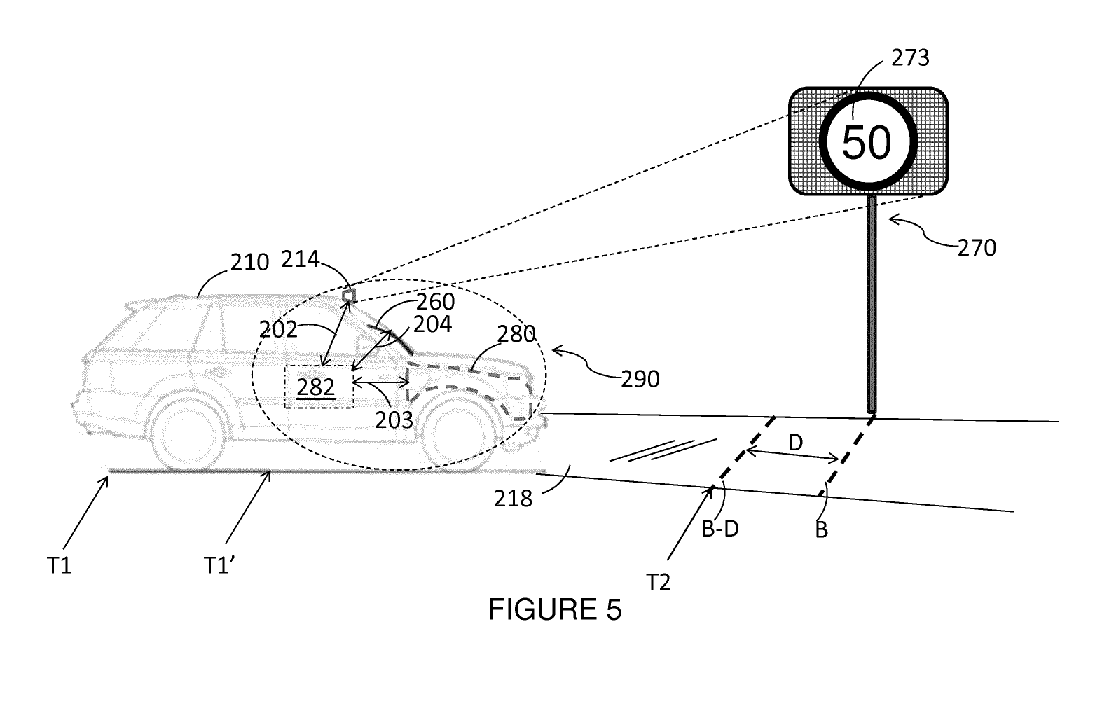

Referring now to FIG. 5, there is shown a further embodiment of an ACC system 290, wherein the system 290 is additionally configured to maintain a vehicle cruise speed that is selected by the driver, either from a range of vehicle speeds or in response to a prompt from the system 290. The system 290 is configured to determine a current legal speed limit and is configured to display or otherwise communicate the current legal speed limit as determined by the system 290 to the driver of the vehicle 210, as an indicated speed limit. The indicated speed limit is provided for prompting the driver of the vehicle 210 to select the indicated speed limit as the vehicle cruise speed in order to improve compliance with the current legal limit.

In envisaged embodiments, the system 290 is optionally additionally configured to determine a current legal speed limit and is configured to determine an appropriate vehicle speed in dependence upon said current legal speed limit as determined by the system and in dependence upon the environmental and/or situational status of the vehicle 210. For example, the appropriate vehicle speed may be determined by applying a modifying fact to the current speed limit, where the modifying factor is based on the status factor (SF) determined in dependence on the environmental and/or situational status of the vehicle (i.e. the modifier may be a number between 0 and 1). Alternatively, the appropriate vehicle speed may be lower one of the current speed limit and a vehicle speed determined by the system, independently of any speed limit, as being appropriate for the type of road/terrain on which the vehicle is travelling. The system 290 again comprises a HMI, which may comprise a visual display and/or an audible alert for displaying or otherwise communicating the determined appropriate vehicle speed to the driver of the vehicle 210 as an indicated speed limit. The purpose of doing this is to suggest a more appropriate and perhaps safer vehicle speed to the driver, for prompting the driver to select the indicated speed limit as the vehicle cruise speed. The system may comprise a means, such as a button mounted on or proximate to a vehicle steering wheel, which the driver of the vehicle 210 can use to select the indicated speed limit as the vehicle cruise speed. Upon a driver selecting the indicated speed limit as the vehicle cruise speed by pressing said button, the system is configured to adopt and maintain the indicated speed limit as the vehicle cruise speed. The determined appropriate vehicle speed may be communicated to the driver as a suggested or advisory vehicle cruise speed, optionally together with the current speed limit as determined by the system. Accordingly, references through the description to the “indicated speed limit”, where this relates to the appropriate vehicle speed determined by the system, may also be taken to be the “advisory vehicle cruise speed”.

Further optionally, the system may comprise a means for a driver to select an off-set speed relative to the indicated speed limit as the vehicle cruise speed and upon a driver selecting said off-set speed relative to the indicated speed limit as the vehicle cruise speed by deploying said means, the system is configured to adopt and maintain the off-set indicated speed limit as the vehicle cruise speed. For example and as in FIG. 5, the vehicle cruise speed is 60 miles per hour (m.p.h.) (97 k.p.h). The system 290 determines that a variable speed limit 273 shown on a sign 270 is 50 m.p.h. (80 k.p.h.). The system 290 additionally determines a status factor SF in dependence upon the environmental and/or situational status of the vehicle 210 and an appropriate speed limit of 50 m.p.h. (80 k.p.h.) is computed. Because this is lower than the current vehicle cruise speed, this is communicated to the driver as an indicated speed limit. The driver may select the indicated speed limit as the vehicle cruise speed, may chose to ignore the prompt or may choose to select an off-set indicated speed limit. Optionally, the permitted off-set range for adjustment of the indicated speed limit is plus or minus 10 kmh⁻¹. In this way, the driver is provided with a degree of freedom about the indicated speed limit which is based upon the current conditions and current legal speed limit. In the present embodiment the driver remains fully in control since he has to take action by pressing an acceptance button before the system 290 will adopt the indicated speed limit (or off-set indicated speed limit) as the new vehicle cruise speed.

Preferably, but nevertheless optionally, the system is configured to display or otherwise communicate the indicated speed limit to a driver of the vehicle for prompting the driver of the vehicle to select the indicated speed limit as the selected vehicle cruise speed, only if the determined indicated speed limit is lower than the vehicle cruise speed already selected by the driver. As per the described and illustrated embodiment of FIG. 5, the indicated speed limit of 50 m.p.h. (80 k.p.h.) is lower than the current vehicle cruise speed (60 m.p.h. (97 k.p.h.)) and as such, the system does communicate this indicated speed limit.

As in the system 190 of FIG. 4, the system 290 is configured to communicate the indicated speed limit to a driver of the vehicle a maximum number of times or for a specified period, before ceasing to communicate the indicated speed limit to a driver of the vehicle. Similarly as with the system 190 continually monitoring the status factor for determining an appropriate headway, in the present embodiment the system 290 is configured to monitor the current legal speed limit and upon determining a change in the current legal speed limit and/or appropriate speed limit, the system 290 is configured to communicate a new indicated speed limit to the driver. Preferably, the new indicated speed limit is communicated for a maximum number of times or for a maximum time period before ceasing to communicate that new indicated speed limit. In the present illustrated arrangement, the maximum number of times is two.

In FIG. 5, it is shown that the system 290 comprises an imager (a camera) 214 and a navigation system. The system 290 may determine the current legal speed limit (including a current variable legal speed limit) using any one or a combination of:
(i) data from the navigation system;
(ii) a traffic sign recognition (TSR) system optionally using imaging of traffic speed limit signs using the camera 214; and
(iii) in envisaged embodiments, data issued by traffic signs or by information media associated therewith.

In a variation of the illustrated embodiment of FIG. 5, the system 290 is configured to automatically adopt the appropriate speed limit which has been determined by the vehicle 210 at least in dependence upon the current legal speed limit (as determined by the system 290 or by a TSR system associated therewith) and optionally in dependence upon the environmental and/or situational status of the vehicle 210. This is providing that the appropriate speed limit is lower than a current vehicle cruise speed as selected by the driver or by the system 290. Additionally, in a region of changing speed limit, the system 290 is structured and arranged to ensure that the vehicle 210 is travelling close to the legal speed limit within a set distance or set time of the physical threshold ‘B’ at which the legal speed limit changes.

In FIG. 5, there is shown a variable speed limit sign 270 showing a new legal variable speed limit 273 of 50 m.p.h (80 k.p.h.) which applies at and after the line marked as ‘B’ in FIG. 5. Before the line ‘B’, the (current) legal speed limit, which the driver of the vehicle 210 is legally required not to exceed, is 60 m.p.h. (97 k.p.h.) (not shown in FIG. 5). In the currently described variation, the system 290 is configured to detect the new variable speed limit using image recognition of the variable speed limit sign 270 ahead of the spatial limit ‘B’ at which that new variable speed limit applies. The outward facing camera 214 is configured to image the environment external and ahead of the vehicle 210. Image recognition software associated with the camera 214 (not shown) is provided for processing the image stream from the camera 214 to detect speed limit signs such as but not limited to a variable speed limit sign such as 270 shown in FIG. 5 and to recognise a new, upcoming legal speed limit 273 shown thereon. As such, the system 290 is capable of detecting in advance of a threshold ‘B’ at which the legal speed limit changes, that the legal speed limit is about to change from a currently determined legal speed limit to a newly determined legal speed limit. In the system 290 wherein the appropriate speed limit as determined by the system 290 (which in some embodiments is simply the legal speed limit irrespective of the environmental and/or situational status of the vehicle 210 and in other embodiments is the legal speed limit decreased by an off-set to account for the environmental and/or situational status of the vehicle 210) is automatically adopted, the rate of deceleration may be computed to ensure that the vehicle 210 has adopted an actual vehicle speed that is the same as or less than the new legal speed limit at or before the speed limit change threshold ‘B’.

To provide a margin for error, the system 290 may utilise a deceleration ramp rate (computed in dependence upon the current vehicle speed, the appropriate vehicle speed and either an estimated distance or time to achieve the appropriate vehicle speed) that will ensure that the vehicle 210 is travelling at an actual vehicle speed that is equal to or less than the new legal speed limit 273 by a predetermined gap ‘D’ from the speed limit change threshold ‘B’. The gap ‘D’ is optionally a distance in metres and is optionally in the range 0.5 m to 5 m; the gap ‘D’ alternatively is a time, optionally in the range 1 s to 3 s.

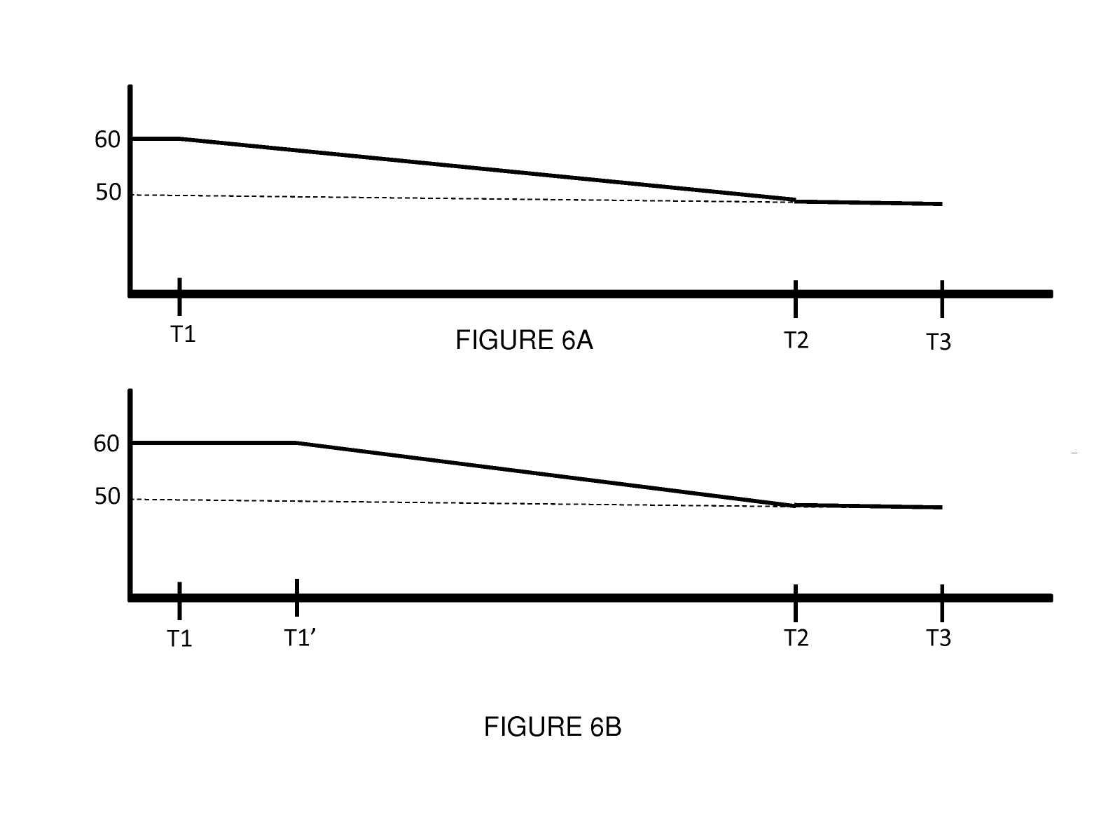

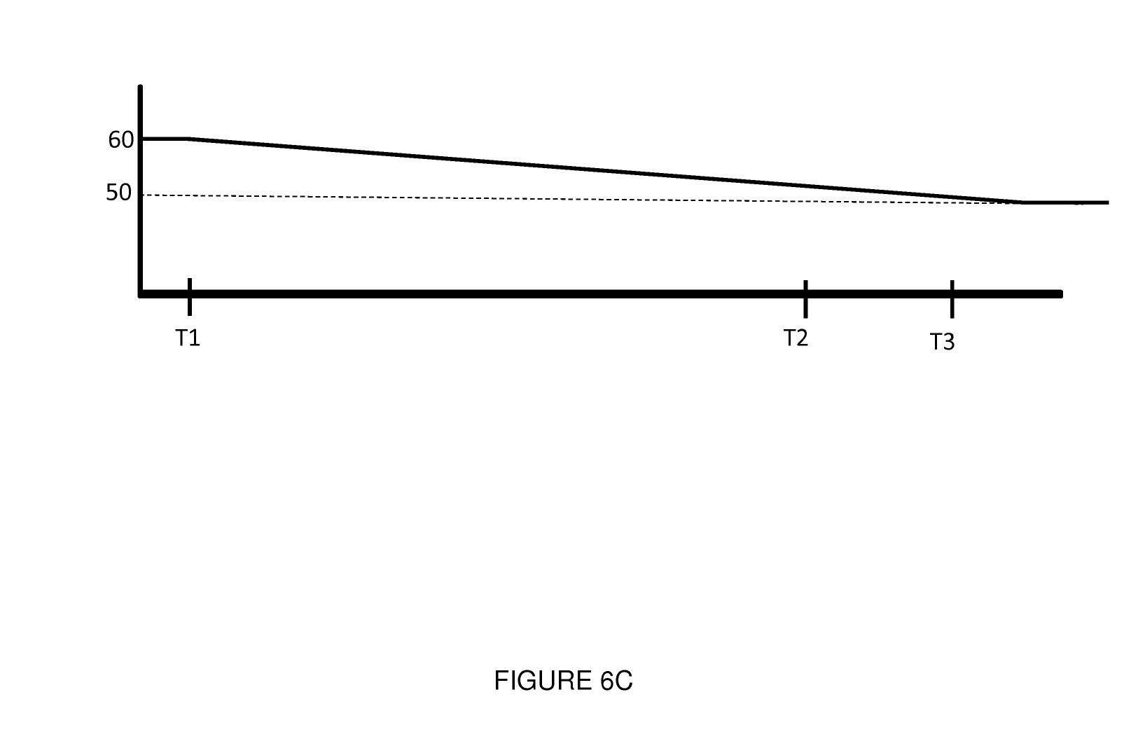

In the illustrated arrangement, the system 290 recognises the new legal speed limit 273 at time T1. The system 290 is configured to estimate the distance to the sign 270 and in dependence upon the current vehicle drive profile (as described above) and the deceleration ramp rate defined therein, the system 290 may begin to decelerate immediately in order to ensure that at time T2 (which represents a gap or margin ‘B-D’ before the sign 270) the vehicle 210 has adopted an actual vehicle speed that is equal to or less than the legal speed limit 273. This is shown graphically in FIG. 6A. Alternatively, dependent upon the starting actual vehicle speed (in this case 60 m.p.h. (97 k.p.h.)) and the deceleration ramp rate defined by the current drive profile, a steeper rate of deceleration may be acceptable (in consideration of the time available before the ‘B-D’ marker is reached and/or in consideration of the status factor ‘SF’). Therefore deceleration may not be automatically commenced until T1’ (see FIG. 6B).

Alternatively, in certain circumstances, priority may be given to the status factor ‘SF’ and the deceleration ramp rate defined in the current driving control profile thereby selected such that if the vehicle's environment or situation (the presence of ice, or heavily laden vehicle for example) requires a more gradual rate of deceleration, the system 290 may prioritise the defined deceleration rate. In such an embodiment, in spite of the fact that deceleration was commenced as early as possible (i.e. at time T1) the actual vehicle speed may not be equal to or less than the new legal limit by the margin threshold ‘B-D’ and indeed may not be equal to or less than the new legal limit by the speed limit change threshold ‘B’. In such a situation, the actual vehicle speed may slightly exceed the new legal limit at the speed limit change threshold ‘B’ in order to ensure the safe deceleration of the vehicle 210 in the given conditions. However, the new legal speed limit will be met shortly thereafter such that the new legal speed limit may only have been contravened by a small amount and for a small amount of time, yet the vehicle 210 was cruise controlled in a safe manner at all times (see FIG. 6C).

It will be recognised that changes may be made herein without departing from the scope of the disclosure.

It will be recognised that as used herein the terms “environmental data” and “situational data” are used for the purposes of explaining the functionality, purpose and benefit of the invention of the disclosure. These terms are not necessarily intended to be limiting and it will be recognised upon reading the foregoing disclosure that a wide variety of data signals from a wide variety of sources may be collected and examined in conjunction with one another in order to determine an appropriate driving profile for the cruise control systems to adopt.

Any received and issued data and command signals may be received and/or issued by wired communications or wireless communications. Preferably, but nevertheless optionally, a wired network is utilised to manage the timing, priority and order of communications within the CAN and/or LIN of a vehicle, which communications may be sporadic, periodic or continuous as appropriate or as required.

Further aspects of the present invention are set out in the following numbered paragraphs:
1. A system for cruise controlling a vehicle, the system comprising a control unit configured to select a driving control profile in dependence upon a determination by the system of an environmental and/or situational status of the vehicle.
2. A system for cruise controlling a vehicle according to paragraph 1 wherein said driving control profile comprises an acceleration profile selected from two or more different acceleration profiles in dependence upon a determination by the system of an environmental and/or situational status of the vehicle and wherein said driving control profile comprises a deceleration profile selected from two or more different deceleration profiles in dependence upon a determination by the system of an environmental and/or situational status of the vehicle.
3. A system for cruise controlling a vehicle according to paragraph 2 wherein the system is configured to determine an environmental and/or situational status of the vehicle by consideration of signals comprising data obtained from sensors or control modules comprised within or mounted to the vehicle and/or from information sources external to the vehicle.
4. A system for cruise controlling a vehicle according to paragraph 3 wherein the system is configured to determine an environmental status of the vehicle by consideration of signals comprising data that include one or more or a combination of:
   (i) whether a rear and/or front wiper speed is above or below a threshold speed;
   (ii) whether a detection of rain by a rain sensor is above or below a rain threshold;
   (iii) whether the front head lights are above or below a first light threshold
   (iv) whether a status of a fog light is above or below a second light threshold;
   (v) whether the ambient temperature is below a threshold temperature; and
   (vi) data from a terrain response control module and/or wherein the system is configured to determine a situational status of the vehicle by consideration of signals comprising data that includes one or more or a combination of:
   (vii) whether tyre pressure of one or more or all of front and/or rear tyres of the vehicle are above or below a threshold pressure range;
   (viii) whether a sports mode is activated;
   (ix) whether a level of light emitted by an HID light is above or below a light level threshold; and
   (x) whether a status of a brake bias valve is above or below a valve threshold.
5. A system for cruise controlling a vehicle according to paragraph 4 wherein said data is used to compute an estimated surface friction mu value of the road upon which the vehicle is travelling and in dependence upon said estimated surface friction mu value an appropriate driving control profile is selected by the system or in dependence upon said estimated surface friction mu value the environmental status is quantified.
6. A system for cruise controlling a vehicle according to paragraph 1 wherein the system controls the vehicle so as to maintain a vehicle cruise speed and wherein the vehicle cruise speed is selected by a driver of the vehicle.
7. A system for cruise controlling a vehicle according to paragraph 6 wherein the system is configured to determine a current legal speed limit and is configured to display or otherwise communicate the current legal speed limit as determined by the system to a driver of the vehicle, as an indicated speed limit, for prompting the driver of the vehicle to select the indicated speed limit as the vehicle cruise speed.
8. A system for cruise controlling a vehicle according to paragraph 7 wherein the system is configured to determine a current legal speed limit and is configured to determine an appropriate vehicle speed in dependence upon said current legal speed limit as determined by the system and in dependence upon an environmental and/or situational status of the vehicle and wherein the system is configured to display or otherwise communicate the determined appropriate vehicle speed to a driver of the vehicle as an indicated speed limit, for prompting the driver of the vehicle to select the indicated speed limit as the vehicle cruise speed, only if the determined indicated speed limit is lower than the vehicle cruise speed already selected by the driver.
9. A system for cruise controlling a vehicle according to paragraph 8 wherein, the system comprises a first selector for a driver to select the indicated speed limit as the vehicle cruise speed and upon a driver selecting the indicated speed limit as the vehicle cruise speed by deploying said first selector, the system is configured to adopt and maintain the indicated speed limit as the vehicle cruise speed.
10. A system for cruise controlling a vehicle according to paragraph 9 wherein, the system comprises a second selector for a driver to select an off-set speed relative to the indicated speed limit as the vehicle cruise speed and upon a driver selecting said off-set speed relative to the indicated speed limit as the vehicle cruise speed by deploying said second selector, the system is configured to adopt and maintain the off-set indicated speed limit as the vehicle cruise speed.
11. A system for cruise controlling a vehicle according to paragraph 8 wherein the system is configured to monitor the current legal speed limit and upon determining a change in the current legal speed limit, the system is configured to determine a new appropriate vehicle speed in dependence upon a new legal speed limit and is configured to communicate the new appropriate vehicle speed as a new indicated speed limit to a driver of the vehicle a maximum number of times before ceasing to communicate that new indicated speed limit.
12. A system for cruise controlling a vehicle according to paragraph 6 wherein the vehicle cruise speed is selected by the system and is automatically adopted by the system and wherein the system is configured and arranged to cause the vehicle to accelerate or decelerate such that the vehicle maintains the vehicle cruise speed and wherein the system is configured to monitor the legal speed limit; is configured to determine a current legal speed limit; and is configured to select the vehicle cruise speed in dependence upon the legal speed limit.
13. A system for cruise controlling a vehicle according to paragraph 12 wherein the system is configured to: determine a new legal speed limit before the vehicle reaches a threshold at which the new legal speed limit applies; determine a new vehicle cruise speed in dependence upon the new legal speed limit; and cause the vehicle to accelerate or decelerate at a sufficient rate such that the actual vehicle speed matches the new vehicle cruise speed within a predefined distance or time gap of the new legal speed limit threshold.
14. A system for cruise controlling a vehicle according to paragraph 13 wherein the system is configured to display or otherwise communicate the new legal speed limit as determined by the system to a driver of the vehicle, as an indicated speed limit, for allowing the driver of the vehicle an opportunity to cancel automatic adoption of the indicated speed limit as the vehicle cruise speed by the system.
15. A system for cruise controlling a vehicle according to paragraph 14 wherein the system is configured to determine an appropriate vehicle speed in dependence upon said current legal speed limit as determined by the system and in dependence upon an environmental and/or situational status of the vehicle as determined by the system and wherein the system is configured to automatically adopt the determined appropriate vehicle speed as the vehicle cruise speed, which appropriate vehicle speed may be equal to or less than the current legal speed limit.
16. A system for cruise controlling a vehicle according to paragraph 15 wherein the system is configured to determine a new appropriate vehicle speed ahead of a threshold at which a new legal speed limit applies and is arranged to cause the vehicle to accelerate or decelerate at a ramp rate determined in dependence upon the environmental and/or situational status of the vehicle as determined by the system such that the actual vehicle speed matches the new vehicle cruise speed, at a distance or time gap relative to the new legal speed limit threshold dependent upon the relative time at which the new legal speed limit is determined and a new appropriate vehicle speed is determined and in dependence upon the starting actual vehicle cruise speed relative to the new appropriate vehicle speed.
17. A system for cruise controlling a vehicle according to paragraph 7 wherein the system determines the current legal speed limit including a current variable legal speed limit using any one or a combination of:
   (i) data from a navigation system;
   (ii) imaging of traffic speed limit signs optionally in conjunction with a traffic sign recognition system; and/or
   (iii) data from a smart speed limit sign or an information medium associated therewith.
18. A vehicle comprising the system of paragraph 1.
19. A method of controlling a vehicle comprising the system of paragraph 1, the method comprising determining an environmental and/or situational status of the vehicle; and selecting in dependence thereon a current driving control profile; and cruise controlling the vehicle using the current driving control profile.
20. A program for a control unit of a vehicle, which when running on the control unit causes the control to carry out a method comprising determining an environmental and/or situational status of the vehicle; and selecting in dependence thereon a current driving control profile; and cruise controlling the vehicle using the current driving control profile.

1. A system for cruise controlling a vehicle, the system comprising a control unit configured to select a driving control profile in dependence upon a determination by the system of an environmental and/or situational status of the vehicle, wherein the driving control profile comprises:
an acceleration profile selected from two or more different acceleration profiles; and/or
a deceleration profile selected from two or more different deceleration profiles.

2. The system for cruise controlling a vehicle according to claim 1, wherein the system is configured to determine the environmental and/or situational status of the vehicle by consideration of signals comprising data obtained from sensors or control modules comprised within or mounted to the vehicle and/or from information sources external to the vehicle.

3. The system for cruise controlling a vehicle according to claim 1, wherein the system is configured to determine the environmental status of the vehicle by consideration of signals comprising data that include one or more or a combination of:
(i) whether a rear and/or front wiper speed is above or below a threshold speed;
(ii) whether a detection of rain by a rain sensor is above or below a rain threshold;
(iii) whether front head lights are above or below a first light threshold;
(iv) whether a status of a fog light is above or below a second light threshold;
(v) whether an ambient temperature is below a threshold temperature; and
(vi) data from a terrain response control module.

4. The system for cruise controlling a vehicle according to claim 2, wherein said data is used to compute an estimated surface friction mu value of a road upon which the vehicle is travelling and in dependence upon said estimated surface friction mu value the driving control profile is selected by the system and/or in dependence upon said estimated surface friction mu value the environmental status is quantified.

5. The system for cruise controlling a vehicle according to claim 3, wherein the data is weighted and summed in order to quantify the environmental status.

6. The system for cruise controlling a vehicle according to claim 2, wherein the system is configured to determine the situational status of the vehicle by consideration of signals comprising data that includes one or more or a combination of:
(i) whether tyre pressure of one or more or all of the front and/or rear tyres is above or below a threshold pressure range;
(ii) whether a sports mode is activated;
(iii) whether a level of light emitted by an HID light is above or below a light level threshold;
(iv) whether a status of a brake bias valve is above or below a valve threshold;
(v) whether a winter mode is activated;
(vi) a lateral acceleration of the vehicle; and
(vii) a yaw rate of the vehicle.

7. The system for cruise controlling a vehicle according to claim 6, wherein the data is weighted and summed in order to quantify the situational status.

8. The system for cruise controlling a vehicle according to claim 7, wherein, in dependence upon the quantified environmental status and in dependence upon a quantified situational status the driving control profile is selected.

9. The system for cruise controlling a vehicle according to claim 1, wherein the system controls the vehicle so as to maintain a vehicle cruise speed.

10. The system for cruise controlling a vehicle according to claim 9, wherein the vehicle cruise speed is selected by a driver of the vehicle.

11. The system for cruise controlling a vehicle according to claim 10, wherein the system is configured to determine a current legal speed limit and is configured to display or otherwise communicate the current legal speed limit as determined by the system to the driver of the vehicle, as an indicated speed limit, for prompting the driver of the vehicle to select the indicated speed limit as the vehicle cruise speed.

12. The system for cruise controlling a vehicle according to claim 10, wherein the system is configured to determine a current legal speed limit and is configured to determine an appropriate vehicle speed in dependence upon said current legal speed limit as determined by the system and in dependence upon the environmental and/or situational status of the vehicle and wherein the system is configured to display or otherwise communicate the determined appropriate vehicle speed to the driver of the vehicle as an indicated speed limit, for prompting the driver of the vehicle to select the indicated speed limit as the vehicle cruise speed.

13-15. (canceled)

16. The system for cruise controlling a vehicle according to claim 11, wherein the system is configured to display or otherwise communicate the indicated speed limit to a driver of the vehicle for prompting the driver of the vehicle to select the indicated speed limit as the selected vehicle cruise speed, only if the determined indicated speed limit is lower than the vehicle cruise speed already selected by the driver.

17-19. (canceled)

20. The system for cruise controlling a vehicle according to claim 9, wherein the vehicle cruise speed is selected by the system and is automatically adopted by the system and wherein the system is configured to cause the vehicle to accelerate or decelerate such that the vehicle maintains the vehicle cruise speed.

21. The system for cruise controlling a vehicle according to claim 20, wherein the system is configured to:
monitor the legal speed limit;
determine a current legal speed limit; and
select the vehicle cruise speed in dependence upon the legal speed limit.

22. The system for cruise controlling a vehicle according to claim 21, wherein the system is configured to:
determine a new legal speed limit before the vehicle reaches a threshold at which the new legal speed limit applies;
determine a new vehicle cruise speed in dependence upon the new legal speed limit; and
cause the vehicle to accelerate or decelerate at a sufficient rate such that the actual vehicle speed matches the new vehicle cruise speed within a predefined distance or time gap of the new legal speed limit threshold.

23-28. (canceled)

29. The system for cruise controlling a vehicle according to claim 9, wherein the system controls the vehicle so as to maintain a vehicle cruise headway.

30. The system for cruise controlling a vehicle according to claim 29, wherein the vehicle cruise headway is selected by a driver of the vehicle, wherein the system is configured to determine an appropriate vehicle headway in dependence upon braking distance data for the vehicle cruise speed and for the environmental and/or the situational status of the vehicle as determined by the system, wherein the system is configured to display or otherwise communicate the determined appropriate vehicle headway to a driver of the vehicle as an indicated headway, for prompting the driver of the vehicle to select the indicated headway as the vehicle cruise headway, and wherein the system comprises a control device for use by the driver to select the indicated headway as the vehicle cruise headway and upon the driver selecting the indicated headway as the vehicle cruise headway by deploying said control device, the system is configured to adopt and maintain the indicated headway as the vehicle cruise headway

31-41. (canceled)

42. A system for cruise controlling a vehicle, the system comprising a camera, and wherein the system is operable to control the vehicle so as to maintain a vehicle cruise speed, the system being configured to:
determine a current legal speed limit using the camera to capture an image of a traffic speed limit sign;
determine an appropriate vehicle speed, the appropriate vehicle speed being a safer recommended speed of travel at or below the determined legal speed limit determined in dependence upon the determined current legal speed limit and upon the environmental and/or the situational status of the vehicle; and
output the determined appropriate vehicle speed for selection as the vehicle cruise speed.

43-65. (canceled)

66. A system for cruise controlling a vehicle, wherein the system is operable to control the vehicle so as to maintain a vehicle cruise headway, the system being configured to determine an appropriate vehicle headway in dependence upon braking distance data for a current vehicle speed and for environmental and/or situational status of the vehicle as determined by the system,
wherein the vehicle cruise headway is selected by a driver of the vehicle,
wherein the system is configured to display or otherwise communicate the determined appropriate vehicle headway to the driver of the vehicle as an indicated headway, for prompting the driver of the vehicle to select the indicated headway as the vehicle cruise headway, and
wherein the system comprises a control device for use by the driver to select the indicated headway as the vehicle cruise headway and upon the driver selecting the indicated headway as the vehicle cruise headway by deploying said control device, the system is configured to adopt and maintain the indicated headway as the vehicle cruise headway.

67-81. (canceled)
